(19) United States
(12) Patent Application Publication
(10) Pub. No.: US 2019/0182196 A1
(43) Pub. Date: Jun. 13, 2019

(54) Handling Communication Messages Based on Urgency

(71) Applicant: Knowmail S.A.L LTD., Petach-Tikva (IL)

(72) Inventors: Oded Avital, Tiqua (IL); Avi Mandelberg, Hod Ha'Sharon (IL); Yury Gubman, Jerusalem (IL); Shmuel Ur, Shorashim (IL)

(21) Appl. No.: 15/840,100

(22) Filed: Dec. 13, 2017

(51) Int. Cl. H04L 12/58

(52) U.S. Cl. CPC H04L 51/26; G06N 99/005

(57) ABSTRACT

A method, system and product for handling communication messages based on urgency. A communication message which was transmitted to a user is obtained. The communication message associated with a multiplicity of attributes. Based on activities of the user when handling previously received communication messages, and based on a current context of the user, an urgency score is determined. The determination comprises estimating a function of a time duration until the user is expected to perform a first action in response to receiving the communication message. A user interface of a communication system is displayed to the user. The display is affected by the urgency score.

### TECHNICAL FIELD

The present disclosure relates to communication messages in general, and to handling communication items based on their urgency, in particular.

### BACKGROUND

Digital communication, and in particular electronic mail, commonly referred to as email, e-mail or simply mail is a method of exchanging digital messages from an author to one or more recipients.

Due to the proliferation of mobile devices which are continuously connected to the internet, communication messages are received by users around the clock, regardless of where the user is, what the user is doing, or what device the user is using. For example, messages may be received when the user is at a meeting, driving, or is occupied with any other activity. This may cause real disturbance to the daily life and interfere with carrying out required activities. In some cases, for example when the user is driving, this may even be dangerous. However, totally ignoring incoming messages is not always an option, as some messages may be related to the current activity of the user. The user may want to see such messages or other urgent messages immediately, in order to take quick actions.

### BRIEF SUMMARY

One exemplary embodiment of the disclosed subject matter is a method comprising: receiving a communication message transmitted to a user, the communication message associated with a multiplicity of attributes; determining, based on activities of the user when handling previously received communication messages, and based on a current context of the user, an urgency score, wherein said determining comprises estimating a function of a time duration until the user is expected to perform a first action in response to receiving the communication message; and displaying a user interface of a communication system to the user, wherein said displaying is affected by the urgency score.

Optionally, subject to the urgency score being below a threshold, said displaying comprises avoiding displaying the communication message; subject to the urgency score being below the threshold, re-evaluating at a later time the urgency score of the communication message to obtain a second urgency score; and subject to the second urgency score being above the threshold, displaying the communication message in the user interface.

Optionally, said determining the urgency score comprises classifying the communication message using a discrete classifier trained upon activities of the user when handling previously received communication messages, to obtain at least the first action the user is likely to perform with the communication message.

Optionally, the method comprises training the discrete classifier upon communication messages received by the user during a preceding predetermined time period.

Optionally, said determining the urgency score further comprises: processing the communication message using a time estimation engine trained upon activities of the user when handling the previously received communication messages, to obtain the time until the user is expected to perform the first action; and determining the urgency score based on a relationship between the time duration and a second threshold.

Optionally, said determining the urgency score further comprises: selecting the time estimation engine from a plurality of time estimation engines, wherein each time estimation engine in the plurality of time estimation engines is associated with a different action, wherein said selecting comprises selecting the time estimation engine that is associated with the first action.

Optionally, the estimation engines uses a model selected from the group consisting of: regression analysis models, survival models for time to event prediction, survival random forest, and classification.

Optionally, the first action is selected from the group consisting of opening the communication message, reading the communication message, replying to the communication message, forwarding the communication message, adding a task, deleting a task, and initiating another communication.

Optionally, subject to the first action not requiring user interaction in order to be performed and subject to the urgency score being above a threshold, performing the first action.

Optionally, the first action is selected from the group consisting of deleting the message, and storing the message in a repository.

Optionally, the method further comprising classifying the communication message using a second discrete classifier trained upon behavior of the user, to obtain a target location in the repository for storing the message.

Optionally, said displaying comprises ordering communication messages in accordance with their respective urgency scores.

Optionally, the method further comprising displaying a reminder reminding to the user to perform the action or to perform a follow-up action.

Another exemplary embodiment of the disclosed subject matter is a computer program product comprising non-transitory computer readable medium retaining instructions, which instructions, when read by a processor, cause the processor to perform a method comprising: receiving a communication message transmitted to a user, the communication message associated with a multiplicity of attributes; determining, based on activities of the user when handling previously received communication messages, and based on a current context of the user, an urgency score, wherein said determining comprises estimating a function of a time duration until the user is expected to perform a first action in response to receiving the communication message; and displaying a user interface of a communication system to the user, wherein said displaying is affected by the urgency score.

Optionally, the method further comprising: subject to the urgency score being below a threshold, said displaying comprises avoiding displaying the communication message; subject to the urgency score being below the threshold, re-evaluating at a later time the urgency score of the communication message to obtain a second urgency score; and subject to the second urgency score being above the threshold, displaying the communication message in the user interface.

Optionally, said determining the urgency score comprises classifying the communication message using a discrete classifier trained upon activities of the user when handling previously received communication messages, to obtain at least the first action the user is likely to perform with the communication message.

Optionally, the discrete classifier is trained based upon communication messages received by the user during a preceding predetermined time period.

Optionally, said determining the urgency score further comprises: processing the communication message using a time estimation engine trained upon activities of is the user when handling the previously received communication messages, to obtain the time until the user is expected to perform the first action; and determining the urgency score based on a relationship between the time duration and a second threshold.

Optionally, said determining the urgency score further comprises: selecting the time estimation engine from a plurality of time estimation engines, wherein each time estimation engine in the plurality of time estimation engines is associated with a different action, wherein said selecting comprises selecting the time estimation engine that is associated with the first action.

Yet another exemplary embodiment of the disclosed subject matter is a computerized apparatus having a processor, the processor being adapted to perform the steps of: receiving a communication message transmitted to a user, the communication message associated with a multiplicity of attributes; determining, based on activities of the user when handling previously received communication messages, and based on a current context of the user, an urgency score, wherein said determining comprises estimating a function of a time duration until the user is expected to perform a first action in response to receiving the communication message; and displaying a user interface of a communication system to the user, wherein said displaying is affected by the urgency score.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a general flowchart diagram of a method of handling communication messages, in accordance with some exemplary embodiments of the disclosed subject matter;

FIG. 1B shows a general flowchart diagram of a method of determining urgency of communication messages and handling the communication according to their urgency, in accordance with some exemplary embodiments of the disclosed subject matter; and

FIG. 2 shows a schematic block diagram of a system for handling communication messages according to their urgency, in accordance with some exemplary embodiments of the disclosed subject matter.

### DETAILED DESCRIPTION

In the present disclosure, the term communication relates to electronic-based communication, in particular e-mail messages. However, the disclosure is also applicable to other communication items, such as instant messages, notification, or the like.

In the description below, the terms “mail”, “e-mail”, “email”, “message”, “communication message” or “communication” are used interchangeably and refer to an electronic communication that may be transmitted by a sender to one or more intended recipients and may be consequently received by devices of such recipients. The term is not limited to any specific protocol. Exemplary protocols for transmitting such messages may include Simple Mail Transfer Protocol (SMTP), Post Office Protocol (POP3), Internet Message Access Protocol (IMAP), Short Message Service (SMS) or the like.

In the description below, the terms “urgency” in the context of a message is relates to the need that a recipient of a message receives it within a time frame which will enable the user to take an action related to the message as he usually does for similar messages.

One technical problem dealt with by the disclosed subject matter is that although e-mail users have gotten used to receiving e-mails anytime, on any device and in any situation, this may pose heavy risks, for example if received when the user is driving. In further situations an incoming mail may distract the user from an important activity, and in yet further situations can simply create overload on the user. However, some mails which are considered urgent, such that the user may need to see them as soon as possible, may have to be displayed even in such situations.

Another technical problem dealt with by the disclosed subject matter relates to a message which is not being identified as urgent at a first point in time, but may become urgent later, thus it may be required to re-evaluate the urgency of messages even if a first evaluation did not provide such urgency.

Yet another technical problem dealt with by the disclosed subject matter is the need to free the user from the need to take the actions related to the messages, wherein the actions can be performed automatically.

One technical solution relates to adjusting when incoming e-mails are displayed to a user, depending on their urgency and on the user status, for example the user's current activity, the type of device the user is using, and possibly additional factors. The e-mail urgency may depend on the type of action, if any, the specific user is expected to take in response to receiving the message. The urgency may further depend on the period of time it is expected for the user to take the action.

If the action the user is expected to take is considered urgent, and the time it would take the user to perform the action is below a threshold, the message may be identified as urgent, and may be displayed to the user, even in a situation where not all messages are displayed, for example when the user is driving.

The urgency assessment may be based on any one or more of the following, as well as on additional factors:
The content or characteristics of the communication, including fields such as title, sender, date, importance as provided by the sender, additional recipients, copied recipients, embedded or attached data such as text, video, audio, or the like, length, or the like;
The means or channel of communication, e.g., whether the communication is a mail, an instant message, a chat message, or the like;
The current activity of the user e.g., whether the user is at the office, driving, in a meeting, at home, at work, at a specific geographical location (for example a message related to a discount at a specific store is more urgent when the user is near the store); and possibly additional factors;
The status of the user's mail box and/or the user's recent activities, for example whether the user has been handling incoming messages lately or not;
Other actions recently taken by the user, which are not related to handling messages, such as composing documents, making calls, summoning meetings, or the like; and
The device the user is using, e.g. desktop computer. Laptop computer, tablet, mobile phone, or the like.

The next action the user is expected to perform may be, but is not limited to any one or more of the following:
reading;
opening an attachment or a link provided within the mail;
replying;
forwarding to another recipient;
deleting;
filing, e.g., storing in a designated repository such as a specific folder;
composing a document such as a text document, a presentation, another communication item such as an e-mail, or the like;
making a phone call;
adding a calendar entry; and
creating an action item, for example in a to-do list.

It will be appreciated that some actions, for example replying, may be urgent, while others, such as deleting, are generally not urgent. Some actions may or may not be urgent, possibly depending also on parameters of the mail, the user, the device used by the user, the user's location, the timing, or the like.

If the message is indeed determined to be urgent, e.g., the next action to be taken by the user regarding this message is expected, for example at a probability greater than a first threshold to be performed within a time period shorter than a second threshold, the message may be determined to be urgent and may be displayed to the user in a determined manner. It will be appreciated that the time may be defined as the time until the user completes the action, or as the time until the user starts the action. In further embodiments, the average time, or any other function of the time, for taking an action can be considered. For example, the function can be that the user is expected at a first probability (for example 60%) to reply or forward within 30 minutes, and a second probability (for example 70%) to read an attachment within one hour.

Another technical solution relates to performing some actions associated with a received message, for the user, without the user intervention, whether the messages are urgent or not. For example, a message can be automatically deleted or filed e.g. stored in a designated folder.

Determining the urgency and determining actions to be carried out automatically can be performed by processing the messages using one or more classifiers or other engines trained upon previous messages received by the user, the actions taken by the user regarding these messages, the period or functions of time it took the user to take the action, the users contacts and relationships, or the like. In some embodiments, the classifiers or engines may be trained upon massages and actions of other users, in order to learn the time periods or function. In further embodiments, a trainer may be based on a combination of the actions and times of the user and of other users.

Yet another technical solution relates to re-evaluating the urgency of a message, if it was not determined to be urgent at an earlier point in time. For example, a meeting invitation can be non-urgent if sent two days before the meeting, but can become urgent half an hour before the designated time.

Yet another technical solution relates to a manner of displaying the message to is the user. In some embodiments, if the message is urgent and thus needs to be displayed, it may be decided to display the full message, display only a header, display a part of the message that caused it to be considered urgent, display the urgent messages in an “urgent” folder, or the like.

In some exemplary embodiments of the disclosure, if a mail is considered urgent but the user does not take the expected action within the assessed time frame, a reminder may be sent to the user, for example the same mail with a “please reply to this mail” header or text. Additionally or alternatively, a reminder regarding a follow-up action which may be required by the user may be displayed. The reminder or follow-up message can be sent in a time determined also in accordance with a time in which other people performed related actions. For example, if all addressees but one replied to a message, a reminder can be sent to that addressee.

In some exemplary embodiments of the disclosure further actions may be considered beyond the first expected action. Determining the next action may consider also the previous expected action. Thus, even if the user took the expected action, or any other action, further assessment can be made regarding a next action the user is expected to take regarding the message.

In some exemplary embodiments of the disclosure, the importance of a mail can also be considered, and combined with its urgency, to determine whether the mail shall be displayed. For example, urgent but unimportant mail may not be displayed.

One technical effect of the disclosure relates to displaying messages to a user based on their urgency, such that urgent messages are displayed, while non-urgent messages are not displayed at a current time in order to save the user unnecessary actions when inappropriate or disturbing the user.

Another technical effect of the disclosure relates to automatically performing expected actions on behalf of the user.

Yet another technical effect of the disclosure relates to re-evaluating the urgency of a message at a later time if the message was not initially urgent, and to providing the users with reminders for urgent messages that have not been timely handled.

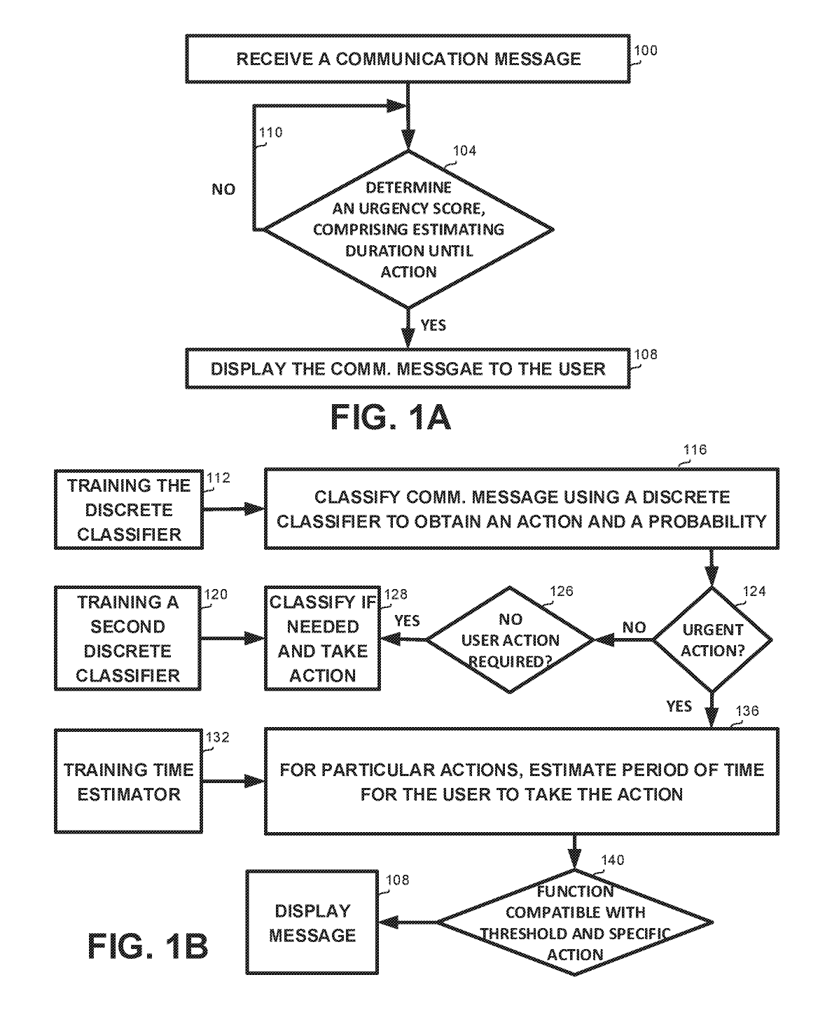

Referring now to FIG. 1A, showing a flowchart diagram of a method for is handling communication messages according to their urgency.

In some embodiments, the method may be performed by an e-mail server in communication with an e-mail client used by the user, prior to transmitting the message to the e-mail client. In other embodiments, the method may be performed by the e-mail client, which may determine, based on the urgency, whether to display the message to the user using an associated display.

On step 100, a communication message, and in particular an e-mail message may be received, for example by a mail server. The message may have several fields, such as title or subject, sender, importance degree as indicated by the sender, additional recipients, or others. The message may further comprise content, which may include text, images, video, a meeting invitation comprising a date, time and possibly location or other details, or the like. The message may further comprise attachments which in themselves may be messages, or text, images, video or the like.

On step 104, an urgency score is determined for the communication message received on step 100, in accordance with the message fields and content, and the current context of its receiver, also referred to as a user, and based on activities of the user when handling previously received communication messages. Determining the urgency score may comprise estimating time duration until the user is expected to perform a first action in response to the communication message. It will be appreciated that the urgency may be determined for the receiver, as the same message can be urgent for one person and non-urgent for another. The term context relates to the current state of the user, for example the user's location or location type, e.g., whether the user is at the office, home, driving, or the like. Additionally or alternatively, the context can refer to a device the user is using, e.g., a phone, a mobile device, a computer, or the like, wherein this information can be retrieved from an organizational server. In some embodiments, if the user is under standard context, for example at the office, determining the urgency can be omitted, any message can be displayed normally. Determining the urgency can be performed only when the user is under another context, for example driving, walking, or the like. In some embodiments, whether urgency should be determined for a particular context may be set by the user, by an IT person of an organization, or the like. For example, it may be set that urgency can be determined for any state other than the user is at the office.

A message may be determined to be urgent if it is assessed that the user is expected to perform a particular action in response to receiving the message, within a predetermined period of time which is shorter than a threshold, or in compliance with another function of the time and action, for example replying with a probability of 50% within half an hour or replying with a probability of 40% within 10 minutes, wherein both options are considered urgent. It will be appreciated that not any expected action may cause the message to be urgent. For example, deleting or filing the message, or adding an action item to a “to-do” list may be considered non-urgent.

If it is determined that the message is indeed urgent, for example the urgency score is above a threshold, then on step 108 a user interface of a communication system such as an e-mail system may be displayed to a user, wherein said displaying is affected by the urgency score. For example, if the urgency score is above a threshold, the user interface may display the communication message fully, partially or in another manner, while if the urgency score is below a threshold, the display can avoid displaying the communication message. In some embodiments, the display manner may depend on the context. For example, if the user is driving, only a header may be displayed, while if the user is at the office, the full contents may be displayed.

If the message is non-urgent, then determining the urgency score can be repeated 110 at a later time, for example after a predetermined period of time, to obtain a second urgency score. If the second urgency score is above the threshold, the communication message may be displayed in the user interface.

Referring now to FIG. 1B, showing a flowchart of a method of determining an urgency scores of a communication message and handling the communication according to its urgency score, in accordance with some exemplary embodiments of the disclosed subject matter.

On step 116, the communication message may be classified by a discrete classifier, to obtain the next action which the receiver is expected to perform upon receiving the message, and optionally a probability of the user performing this action. The classifier is discrete, since there is a predetermined number of possible actions, including for example reading, accessing a link or opening an attachment, replying, forwarding, accepting/rejecting a meeting, adding a meeting to a calendar, adding an item to a to-do list, composing a document, making a phone call, deleting the message, filing the message, and possibly others.

The discrete classifier may be trained on step 112 prior to the classification. The discrete classifier may be trained periodically, for example every day, upon messages received in a predetermined preceding time window, for example a day, a week, a month, a year, or any other sliding time window. Training can receive as input the received messages, the action or actions taken by the user in response to receiving the message, and optionally parameters thereof. The classifier can then learn the association of a message having particular fields and/or content with the user's action, and apply this association when classifying the message on step 116.

On step 124, it may be determined whether the action expected to be performed by the user is urgent, e.g., whether it is one of a collection of action types defined as urgent and that requires action by the user for which the message needs to be displayed, e.g., replying or forwarding a mail. If the classification of step 116 provided a probability for the action, it may be required that the probability exceeds a predetermined threshold, for example 25%, 50%, 75% or the like.

On step 126, it may be determined whether the action expected to be performed by the user is of a particular type that may be performed without user intervention. Such actions may include but are not limited to deleting the message and filing the message. If the urgency score is above a threshold and the action can indeed be performed automatically, then on step 128 the action is performed automatically, otherwise no specific action is taken and the message may be handled normally. It will be appreciated that some actions which are considered to be urgent can be performed automatically, for example forwarding to a predetermined addressee.

In some cases, for example when the action relates to filing the message, parameters required for the action such as the location where the message should be filed file may be retrieved by classifying the message using a second discrete classifier. The second discrete classifier may classify a message to obtain a location to file the message therein. Similarly to step 112 above, the second classifier can be trained on step 120 in order to learn the association of a filed message having particular fields and/or content with a location to which the message has been filed. This association can then be applied when classifying the message on step 124 if the action is filing. It will be appreciated that further automatic actions can be performed, which may require further classifiers and training thereof.

If the action is urgent, then on step 136 the message may be processed by an engine to obtain an estimated time or function of the period of time for the user to take the first action related to the message. The function may be a constant, for example first action within 30 mins, but can also be more complex, such as 60% probability to reply or forward within 30 minutes, and 80% probability to reply or forward within two hours.

The engine may employ any machine learning technique for continuous goal variable estimation, such as but not limited to regression analysis models, survival models for time to event prediction, survival random forest, or the like,

The employed technique may require the definition of a metric for defining distance between points, in order to assess the accuracy of the time estimation. For example, any one or more of the following metrics may be used: Mean Square Error (MSE), Mean Absolute Error (MAE), Mean Absolute Percentage Error (MAPE) or others. Additionally or alternatively, the time series approach may be also used for accuracy assessment, in which the value at point in time t is given, the value at t+dt is predicted and then compared to the actual value at t+dt.

For employing any of the techniques, a set of features is constructed, based for example on fields of the messages, user's behavior, user's response time or the like.

In some embodiments, a classifier may be used for obtaining the expected response time. wherein each class is associated with a time range, for example 0-10 minutes, 10-30 minutes, or the like.

The time estimation engine can be selected from a plurality of engines, each associated with a different action, wherein the engine associated with the action is selected.

The time estimation engine can be trained on step 132, upon past messages, actions taken by the user upon these messages and the time it took the user to take the action. The employed technique may utilize the time to action distribution of the user, such as log-normal, Weibull, or others, in order to build relevant model that provides useful and accurate predictions.

If the used engine is a classifier, the classifier may be associated with a multiplicity of classes, each related to a time range.

It will be appreciated that unlike other systems, training of all engines, is including classifiers, may be based upon the whole corpus of past messages within the predetermined time window. Since there is no need to manually label the messages because the taken actions are known, it may not be required to train the engines upon some of the messages in order to process other past messages. Thus, the engines in accordance with the disclosure relate to supervised learning with a sliding time window.

It will be appreciated that the engines can be trained separately, together by the same learning module at the same time or at different times, concurrently by separate trainers, or the like.

All engines can be trained by the same computing platform or by different computing platforms.

The engines can be based on the random forest model, or the survival random forest model, wherein the survival event may relate to the first action taken by the user. Additionally or alternatively, one or more of the classifiers can be based on a Cox model, or employ regression modeling.

On step 140, an urgency score may be determined, based on a relationship between the function and a second threshold, for example whether the time duration is smaller than the threshold, or whether the probability to answer within the threshold exceeds a predetermined value.

if the time in which the user is expected to perform the action is shorter than a threshold

The threshold can be the same for all actions. Alternatively, each action may be associated with a particular time. The threshold can be determined statically, for example arbitrarily, or based on the current context of the user. For example, if the user is driving, the user's expected arrival time can be estimated from a navigation device or from an item in the calendar indicating where and when the user is expected to be.

If the message is urgent, then on step 108 it may be displayed to the user as detailed above. The message may be displayed in accordance with the user's context, for example if the user is driving then only the header may be presented, or the like. For some types of communication messages, for example instant messages, urgency can be expressed by playing a sound when the message is displayed in order to further attract the user's attention. In further embodiments, such sound may be enabled even if the device is on silent mode. In some embodiments, messages having higher urgency scores is can be displayed before other messages, such that they are more noticeable by the user.

In some embodiments, messages associated with certain actions, for example replying, can be displayed more prominently than other messages.

In some embodiments, the importance of a message may also be assessed, and combined with the urgency, such that only messages that are both urgent and important are displayed to the user if the user is not in a standard context, e.g., at the office.

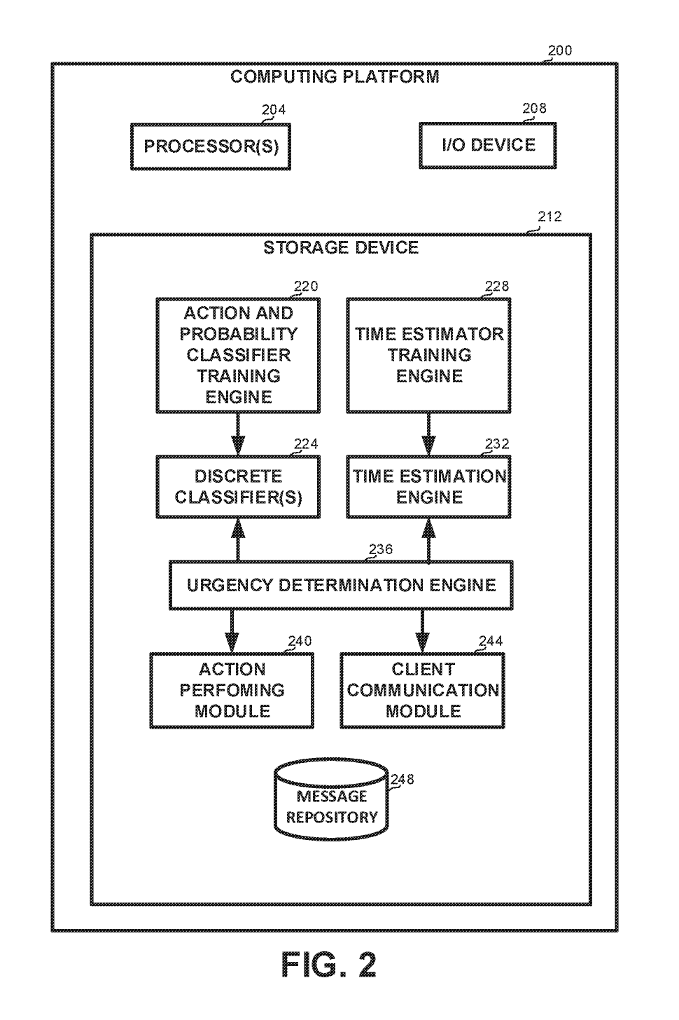

Referring bow to FIG. 2, showing a schematic block diagram of a computing platform for displaying messages according to their urgency, in accordance with the disclosure.

In some exemplary embodiments, the apparatus may be implemented as computing platform 200 such as a mail server, or the like. In other embodiments, computing platform 200 can be a standalone device associated with the user, such a desktop computer, laptop computer or mobile phone, wherein urgent messages (or non-urgent messages under non-urgent context) are displayed on a display device associated with computing platform 200.

Computing platform 200 may comprise one or more processor(s) 204. Processor 204 may be a Central Processing Unit (CPU), a microprocessor, an electronic circuit, an Integrated Circuit (IC) or the like. Processor 204 may be utilized to perform computations required by computing platform 200 or any of it subcomponents.

In some exemplary embodiments of the disclosed subject matter, computing platform 200 may comprise an Input/Output (I/O) device 208 such as a display, a pointing device, a keyboard, a touch screen, or the like. I/O device 208 may be utilized to provide output to and receive input from a user.

In some exemplary embodiments, computing platform 200 may comprise a storage device 212. Storage device 212 may be a hard disk drive, a Flash disk, a Random Access Memory (RAM), a memory chip, or the like. Storage device 212 can comprise or be operatively connected to a multiplicity of storage devices, which may be collocated or located at different locations. In some exemplary embodiments, storage device 212 may retain program code operative to cause processor 204 to perform acts associated with any of the subcomponents of computing platform 200. The components detailed below may be implemented as one or more sets of interrelated computer instructions, executed for example by processor 204 or by another processor. The components may be arranged as one or more executable files, dynamic libraries, static libraries, methods, functions, services, or the like, programmed in any programming language and under any computing environment.

Storage device 212 may store one or more discrete classifier(s) 224, configured to receive a message, and classify it into one or more classes, for example retrieve an action likely to be performed by a user upon receiving the message, a location to which the user is likely to file the message (subject to the user being likely to file the message), or the like.

Storage device 212 may store one or more time estimation engines 232, configured to receive a message, and obtain a time, a time range, or a function, such as a length of time during which a user is likely to perform an action in response to receiving the message, as detailed above.

Storage device 212 may store action and probability classifier training engine 220 which may receive messages and actions taken upon receiving the messages, and train classifier 224.

Storage device 212 may store time estimator training engine 228 which may receive messages and a value selected from a continuous range, for example the time it took a user to take an action in response to receiving such messages, and train time estimation engine 232 accordingly.

It will be appreciated that action and probability classifier training engine 220 and/or time estimator training engine 228 can be stored on another storage device and/or executed by another computing platform, in which case the corresponding classifiers as trained are provided to computing platform 200.

Storage device 212 may store urgency determination engine 236, for receiving a message and optionally one or more classes/values to which the message has been classified by discrete classifier 224 or time estimation engine 232, and determine whether the message is urgent, in accordance for example with the method disclosed on FIG. 1B above. One or more classification results may be provided upon a request by urgency determination engine 236 rather than received a-priori.

Storage device 212 may store action performing module 240 for automatically performing operations, such as deleting or filing a message.

Storage device 212 may store client communication module 244, for communicating with a client device, for retrieving client context of the client, for example which devices a client is using, what is the state and location of the user, or the like. Client communication module 244 can be also configured for receiving the message and displaying it on a display device such as I/O device 208.

Storage device 212 can also store message repository 248, storing messages and optionally additional data, such as classification results thereof, actions taken upon the message, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving a communication message transmitted to a user, the communication message associated with a multiplicity of attributes;
determining, based on activities of the user when handling previously received communication messages, and based on a current context of the user, an urgency score, wherein said determining comprises estimating a function of a time duration until the user is expected to perform a first action in response to receiving the communication message; and
displaying a user interface of a communication system to the user, wherein said displaying is affected by the urgency score.

2. The method of claim 1, further comprising:
subject to the urgency score being below a threshold, said displaying comprises avoiding displaying the communication message;
subject to the urgency score being below the threshold, re-evaluating at a later time the urgency score of the communication message to obtain a second urgency score; and
subject to the second urgency score being above the threshold, displaying the communication message in the user interface.

3. The method of claim 1, wherein said determining the urgency score comprises classifying the communication message using a discrete classifier trained upon activities of the user when handling previously received communication messages, to obtain at least the first action the user is likely to perform with the communication message.

4. The method of claim 3, further comprising training the discrete classifier upon communication messages received by the user during a preceding predetermined time period.

5. The method of claim 3, wherein said determining the urgency score further comprises:
processing the communication message using a time estimation engine trained upon activities of the user when handling the previously received communication messages, to obtain the time until the user is expected to perform the first action; and
determining the urgency score based on a relationship between the time duration and a second threshold.

6. The method of claim 5, wherein said determining the urgency score further comprises: selecting the time estimation engine from a plurality of time estimation engines, wherein each time estimation engine in the plurality of time estimation engines is associated with a different action, wherein said selecting comprises selecting the time estimation engine that is associated with the first action.

7. The method of claim 6, wherein the estimation engines uses a model selected from the group consisting of: regression analysis models, survival models for time to event prediction, survival random forest, and classification.

8. The method of claim 1, wherein the first action is selected from the group consisting of opening the communication message, reading the communication message, replying to the communication message, forwarding the communication message, adding a task, deleting a task, and initiating another communication.

9. The method of claim 1, wherein subject to the first action not requiring user interaction in order to be performed and subject to the urgency score being above a threshold, performing the first action.

10. The method of claim 9, wherein the first action is selected from the group consisting of deleting the message, and storing the message in a repository.

11. The method of claim 10, further comprising classifying the communication message using a second discrete classifier trained upon behavior of the user, to obtain a target location in the repository for storing the message.

12. The method of claim 1, wherein said displaying comprises ordering communication messages in accordance with their respective urgency scores.

13. The method of claim 1, further comprising displaying a reminder reminding to the user to perform the action or to perform a follow-up action.

14. A computer program product comprising non-transitory computer readable medium retaining instructions, which instructions, when read by a processor, cause the processor to perform a method comprising:
receiving a communication message transmitted to a user, the communication message associated with a multiplicity of attributes;
determining, based on activities of the user when handling previously received communication messages, and based on a current context of the user, an urgency score, wherein said determining comprises estimating a function of a time duration until the user is expected to perform a first action in response to receiving the communication message; and
displaying a user interface of a communication system to the user, wherein said displaying is affected by the urgency score.

15. The computer program product of claim 14, wherein the method further comprising:
subject to the urgency score being below a threshold, said displaying comprises avoiding displaying the communication message;
subject to the urgency score being below the threshold, re-evaluating at a later time the urgency score of the communication message to obtain a second urgency score; and
subject to the second urgency score being above the threshold, displaying the communication message in the user interface.

16. The computer program product of claim 14, wherein said determining the urgency score comprises classifying the communication message using a discrete classifier trained upon activities of the user when handling previously received communication messages, to obtain at least the first action the user is likely to perform with the communication message.

17. The computer program product of claim 16, wherein the discrete classifier is trained based upon communication messages received by the user during a preceding predetermined time period.

18. The computer program product of claim 16, wherein said determining the urgency score further comprises:
processing the communication message using a time estimation engine trained upon activities of the user when handling the previously received communication messages, to obtain the time until the user is expected to perform the first action; and
determining the urgency score based on a relationship between the time duration and a second threshold.

19. The computer program product of claim 18, wherein said determining the urgency score further comprises: selecting the time estimation engine from a plurality of time estimation engines, wherein each time estimation engine in the plurality of time estimation engines is associated with a different action, wherein said selecting comprises selecting the time estimation engine that is associated with the first action.

20. A computerized apparatus having a processor, the processor being adapted to perform the steps of:
receiving a communication message transmitted to a user, the communication message associated with a multiplicity of attributes;
determining, based on activities of the user when handling previously received communication messages, and based on a current context of the user, an urgency score, wherein said determining comprises estimating a function of a time duration until the user is expected to perform a first action in response to receiving the communication message; and
displaying a user interface of a communication system to the user, wherein said displaying is affected by the urgency score.
